(19) United States
(12) Patent Application Publication
(10) Pub. No.: US 2018/0008054 A1
(43) Pub. Date: Jan. 11, 2018

(54) INTEGRATED CHANGING TABLE

(71) Applicant: FORD GLOBAL TECHNOLOGIES, LLC, Dearborn, MI (US)

(72) Inventors: Carmen Frida Vargas Garcia, Cuautitlan Izcalli (MX); Luis Adrian Tena Han, Tlalnepantla de Baz (MX)

(21) Appl. No.: 15/204,198

(22) Filed: Jul. 7, 2016

(51) Int. Cl. A47D 5/00; A47D 15/00; B60N 3/00; B60N 3/08

(52) U.S. Cl. CPC A47D 5/006; B60N 3/08; A47D 5/003; A47D 15/005; B60N 3/004

(57) ABSTRACT

An integrated changing table assembly includes a pivoting panel associated with a vehicle seatback, the pivoting panel including at least one deployable leg member configured for engaging a vehicle cargo area floor when the pivoting panel is deployed. The pivoting panel may be stowed in a recess defined in the vehicle seatback. Additional features may include a safety strap associated with a topmost surface of the deployed panel and a holder associated with a surface of the pivoting panel.

### TECHNICAL FIELD

This disclosure relates generally to accessories for motor vehicles, and more particularly to an integrated changing table assembly for a vehicle.

### BACKGROUND

Vehicle users traveling with infants, toddlers, etc. must often stop to change the child's diaper and to otherwise attend to the child's needs during a trip. While it is possible to complete these tasks by placing the child on a vehicle seat or on a floor of a vehicle cargo area, this is inconvenient and may raise issues of safety, as the child could roll off of the vehicle seat. Use of public changing stations, for example at rest stops, service stations, and the like may be inconvenient and raises issues of hygiene.

To solve these and other problems, the present disclosure relates to an integrated changing table assembly for a vehicle. Advantageously, the described assembly may be deployed for use as a changing station at need, and when not in use conveniently folds up into a vehicle seatback structure.

### SUMMARY

In accordance with the purposes and benefits described herein, in one aspect of the present disclosure an integrated changing table assembly is described, comprising a pivoting panel associated with a vehicle seatback. The pivoting panel includes at least one deployable leg member configured for engaging a vehicle cargo area floor when the pivoting panel is deployed. In embodiments, the pivoting panel is stowed in a recess defined in the vehicle seatback and may include a handle for use in deploying the panel.

In embodiments, the pivoting panel may also include a safety strap associated with a topmost surface of the panel when deployed, for use in restraining a child placed on the panel for changing. In embodiments, the pivoting panel further includes a holder such as a net bag associated with a surface thereof.

In another aspect, motor vehicle seat assemblies are described including the integrated changing table assembly as disclosed above. In embodiments, the seat assemblies may be second- or third-row seats disposed adjacent to a vehicle cargo area.

In the following description, there are shown and described embodiments of the disclosed integrated changing table assembly. As it should be realized, the assembly is capable of other, different embodiments and its several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed integrated changing table assembly, and together with the description serve to explain certain principles thereof. In the drawing:

FIG. 1 depicts a vehicle including a stowed integrated changing table assembly according to the present disclosure;

FIG. 2 depicts the integrated changing table assembly of FIG. 1 in a deployed position; and

FIG. 3 depicts the integrated changing table assembly of FIG. 2 in use.

Reference will now be made in detail to embodiments of the disclosed integrated changing table assembly, examples of which are illustrated in the accompanying drawing figures.

### DETAILED DESCRIPTION

Preliminarily, the present disclosure primarily describes a changing table assembly associated with a vehicle seatback, for example a second- or third-row seat of a vehicle having an enclosed cargo area such as a sport-utility vehicle, cross-over utility vehicle, van, and the like. However, the skilled artisan will appreciate from the disclosure that the described system is readily adaptable to seatback structures of other types of vehicle. Accordingly, the descriptions and drawings that follow will not be taken as limiting in regard to the above-described features.

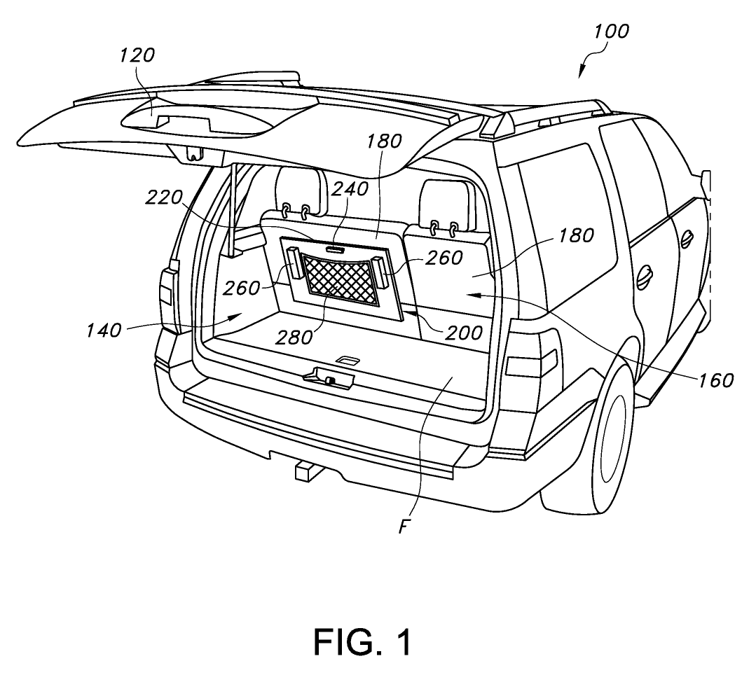

With reference to FIG. 1, there is depicted a vehicle 100 including a rear liftgate closure 120 associated with a cargo area 140. As shown, a seat assembly 160 is disposed adjacent to the cargo area 140. This may be a second-row or third-row seat assembly 160 as is known in the art, and may comprise a split back seat structure, a bench seat structure, and others. The seat assembly 160 comprises a seat member including a seat portion (not shown) and one or more seatback portions 180. An integrated changing table 200 is associated with a rear, cargo area-adjacent surface of the seatback portion 180.

The integrated changing table 200 includes a pivoting panel 220, a handle 240 and at least one deployable support member 260. In the depicted embodiment, the at least one deployable support member 260 comprises a pair of folding leg members. Of course, inclusion of fewer or additional deployable support members 260 is contemplated according to an anticipated size of the pivoting panel 220 and/or an anticipated weight which the pivoting panel 220 is to support. Other optional features may be included, such as a holder 280 for holding needed or useful items. In the depicted embodiment, holder 280 is a net bag, although other structures are contemplated. The holder 280 can be dimensioned for use in holding any desired item, for example diapers, baby wipes, trash bags, etc.

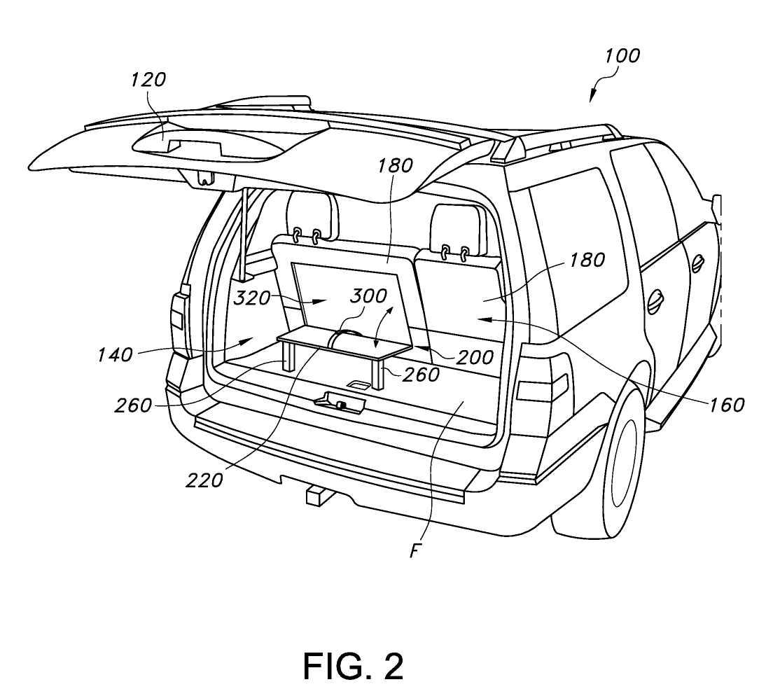

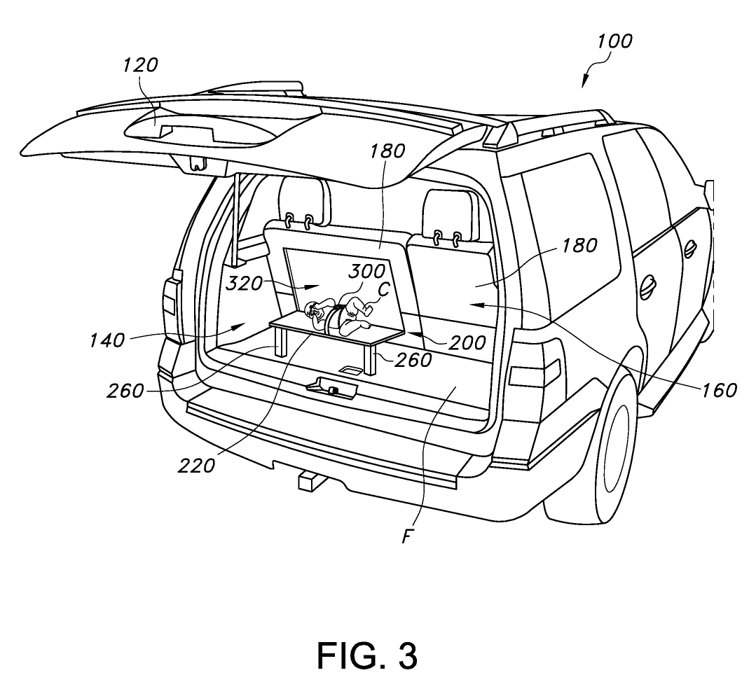

The pivoting panel 220 is pivotally connected to a portion of the seatback portion 180, such as the seatback frame (not shown), by one or more hinges (not shown). To use the integrated changing table 200, a user need only grasp handle 240 and rotate the pivoting panel 220 outwardly (see arrow) to the deployed position seen in FIG. 2. The deployable support members 260 likewise pivot outwardly to engage a floor F of the cargo area 140, thus providing a stable support. In the depicted embodiment, a safety strap 300 is provided, allowing a child C to be substantially secured to a topmost surface of the deployed pivoting panel 220 at need. This provides a suitable safety mechanism to prevent the child from rolling off of the pivoting panel 220 during the diaper changing or other task being performed (see FIG. 3).

Of course, alternative support mechanisms such as locking hinges (not shown), brackets (not shown), and the like are contemplated for maintaining the pivoting panel 220 in the substantially horizontal deployed position shown in FIG. 2. All such mechanisms are contemplated for inclusion herein.

The pivoting panel 220 may simply be hingedly connected to the seatback portion 180, in a substantially parallel stacked configuration. However, in the depicted embodiment a recess 320 is defined in the seatback portion 180, dimensioned to snugly receive the pivoting panel 220 therein when stowed. This provides a more flush, aesthetically pleasing appearance. The pivoting panel 220 may be held in the recess 320 by any suitable mechanism, including by a suitable friction or interference fit therebetween, by use of various clips or pins (not shown), by a latching mechanism (not shown), and the like. Further to improve aesthetics, a bottom surface of the pivoting panel 220 may be fabricated or otherwise treated to provide a similar appearance as the rearmost surface of the seatback portion 180. This can be accomplished by, for example, covering the bottom surface of the pivoting panel 220 with a like fabric or other material, providing a more seamless appearance to the seatback portion 180 when the integrated changing table 200 is stowed as shown in FIG. 1.

As will be appreciated, numerous benefits and advantages accrue from the above-described integrated changing table 200. The integrated changing table 200 is made readily available simply by deploying as described above, providing a convenient and safe changing station for the vehicle user at need. Once the diaper change or other task is accomplished, the integrated changing table 200 is then easily stowed, and so does not take up useful cargo area space when not in use. Still more, the integrated changing table 200 provides a convenient, readily available work surface within the vehicle even if use in diaper changing or other child-related tasks is not contemplated.

Obvious modifications and variations are possible in light of the above teachings. All such modifications and variations are within the scope of the appended claims when interpreted in accordance with the breadth to which they are fairly, legally and equitably entitled.

What is claimed:

1. An integrated changing table assembly, comprising a pivoting panel associated with a vehicle seatback, the pivoting panel including at least one deployable support member configured for engaging a vehicle cargo area floor when the pivoting panel is deployed.

2. The assembly of claim 1, wherein the pivoting panel is stowed in a recess defined in the vehicle seatback.

3. The assembly of claim 2, wherein the pivoting panel includes a handle.

4. The assembly of claim 2, wherein the pivoting panel includes a safety strap associated with a topmost surface of the deployed panel.

5. The assembly of claim 1, wherein the pivoting panel further includes a holder associated with a surface thereof.

6. The assembly of claim 5, wherein the holder is a net bag.

7. A motor vehicle including the assembly of claim 1.

8. A motor vehicle seat assembly, comprising:
at least one seat member comprising a seat portion and a seatback portion; and
an integrated changing table assembly comprising a pivoting panel associated with a rear surface of the seatback portion, the pivoting panel including at least one deployable support member configured for engaging a vehicle cargo area floor when the pivoting panel is deployed.

9. The assembly of claim 8, wherein the pivoting panel is stowed in a recess defined in the rear surface of the seatback portion.

10. The assembly of claim 9, wherein the pivoting panel includes a handle.

11. The assembly of claim 9, wherein the pivoting panel includes a safety strap associated with a topmost surface of the deployed panel.

12. The assembly of claim 8, wherein the pivoting panel further includes a holder associated with a surface thereof.

13. The assembly of claim 12, wherein the holder is a net bag.

14. The assembly of claim 8, wherein the at least one seat member is a second- or third-row seat member positioned adjacent to the vehicle cargo area.

15. A motor vehicle including the assembly of claim 8.

16. A motor vehicle second- or third-row seat assembly, comprising:
at least one seat member comprising a seat portion and a seatback portion; and
an integrated changing table assembly configured for translating between a stowed position within a recess defined in a rear surface of the seatback portion and a deployed position and comprising a pivoting panel including at least one deployable support member configured for engaging a vehicle cargo area floor when the pivoting panel is deployed.

17. The assembly of claim 16, wherein the pivoting panel includes a safety strap associated with a topmost surface of the deployed panel.

18. The assembly of claim 16, wherein the pivoting panel further includes a holder associated with a surface thereof.

19. The assembly of claim 18, wherein the holder is a net bag.

20. A motor vehicle including the assembly of claim 16.
